(19) United States
(12) Patent Application Publication
(10) Pub. No.: US 2026/0237777 A1
(43) Pub. Date: Aug. 13, 2026

(54) BATTERY PACK AND ITS CONTROL METHOD

(71) Applicant: TECHTRONIC CORDLESS GP, Anderson, SC (US)

(72) Inventors: Hei Man LEE, Hong Kong (CN); Jin Hui ZHOU, Dongguan City (CN); Dian Wu XU, Dongguan City (CN); Kui ZENG, Dongguan City (CN); Pei LIAO, Dongguan City (CN)

(21) Appl. No.: 19/474,641

(22) PCT Filed: Apr. 13, 2023
(86) PCT No.: PCT/CN2023/087992

§ 371 Date: Oct. 10, 2025

(51) Int. Cl. H01M 10/6235; H01M 10/42; H01M 10/48; H01M 10/613; H01M 10/63; H01M 10/6551; H01M 10/6563; H01M 10/6566; H01M 50/247; H01M 50/30

(52) U.S. Cl. CPC H01M 10/6235; H01M 10/425; H01M 10/486; H01M 10/488; H01M 10/613; H01M 10/63; H01M 10/6551; H01M 10/6563; H01M 10/6566; H01M 50/247; H01M 50/394; H01M 2010/4271

(57) ABSTRACT

A battery pack including a housing having a first side, a second side positioned opposite the first side, a third side positioned adjacent to both the first side and the second side, a fourth side positioned opposite the third side, an air inlet disposed on the first side, and an air outlet disposed on the second side. The battery pack also includes a plurality of battery cells, a fan positioned within the housing, a temperature sensor that senses a temperature, and an electronic controller that receives a signal from the temperature sensor, determines the temperature, determines whether the temperature is greater than a first temperature threshold, and turns on the fan for a first speed to move air from the air inlet to the air outlet.

### FIELD OF THE DISCLOSURE

The present disclosure relates to battery packs, and more specifically, battery packs for devices such as power tools.

### SUMMARY OF THE DISCLOSURE

Battery packs may couple to a battery charger to charge the battery packs by receiving a charging current from the battery charger. Battery packs may also couple to a device (e.g., a power tool) and provide operational power to the device. Battery packs may experience overheating conditions when being charged and/or when providing operational power to a device. Thus, battery packs may also include a cooling fan to provide cooling air to the battery pack and/or internal components of the battery pack. Battery packs may further include an air inlet and an air outlet to direct cooling air to internal components of the battery pack, however known designs may be met with air intake control, air exhaust control, and size constraints.

The disclosure provides, in one aspect, a battery including a housing having a first side facing a front direction, a second side positioned opposite the first side, a third side positioned adjacent to both the first side and the second side, a fourth side positioned opposite the third side, an air inlet disposed on the first side, and an air outlet disposed on the second side. The battery pack also includes a plurality of battery cells and a fan positioned within the housing. The battery pack also includes a temperature sensor. The temperature sensor senses a temperature. The battery pack also includes an electronic controller that receives a signal from the temperature sensor. The electronic controller determines, based on the signal, the temperature. The electronic controller determines whether the temperature is greater than a first temperature threshold. The electronic controller turns on the fan for a first speed to move air from the air inlet to the air outlet in response to determining that the temperature is greater than the first temperature threshold.

In some aspects, the battery pack includes an interface for mating with an external device, the air outlet includes the interface.

In some aspects, the electronic controller is provided on a PCB, a channel is formed between the PCB and the battery cells and/or between the PCB and the housing, and the fan moves air through the channel

In some aspects, the battery includes a plurality of channels, each channel of the plurality of channels is positioned between two adjacent battery cells of the plurality of battery cells, and the fan moves air through the plurality of channels.

In some aspects, the fan is positioned proximate to the air inlet or the air outlet.

In some aspects, the fan is located below a LED gauge.

In some aspects, the fan pulls air through the air inlet, cools the battery cells and/or the electronic controller using the air pulled from the air inlet, and exhausts the air from the air outlet.

In some aspects, the PCB includes a heatsink attached to heat generating components, the heatsink is positioned in the channel.

In some aspects, if the temperature is higher than a second temperature threshold, the electronic controller controls the fan to run in a second speed, wherein the second temperature threshold is higher than the first temperature threshold, the second speed is higher than the first speed.

In some aspects, the LED gauge shows the status of the fan.

In some aspects, the fan is arranged in parallel to the battery cells.

In some aspects, each battery cell of the plurality of battery cells includes a first battery terminal and a second battery terminal, each first battery terminal is positioned proximate to the third side, each second battery terminal is positioned proximate to the fourth side.

In some aspects, the air inlet includes a first plurality of openings for air to pass through and the air outlet includes a second plurality of openings for air to pass through.

In some aspects, the fan pulls air through the air inlet, cools the battery cells using the air pulled from the air inlet, and exhausts the air from the air outlet.

The disclosure provides, in another aspect, a method for controlling a temperature of a battery pack including an electronic controller. The method includes receiving, via the electronic controller, a signal from a temperature sensor. The method further includes determining, via the electronic controller and based on the signal, a temperature. The method further includes determining, via the electronic controller, whether the temperature is greater than a temperature threshold. The method further includes turning on a fan to move air from an air inlet to an air outlet in response to determining that the temperature is greater than the temperature threshold.

In some aspects, the battery includes a plurality of channels, each channel of the plurality of channels is positioned between two adjacent battery cells of the plurality of battery cells.

In some aspects, turning on the fan moves air through the plurality of channels.

In some aspects, the air inlet further includes a first plurality of openings for air to pass through and the air outlet further includes a second plurality of openings for air to pass through.

In some aspects, the method further includes pulling air, via the fan, through the air inlet. The method further includes cooling the battery cells using the air pulled from the air inlet. The method further includes exhausting the air from the air outlet.

In some aspects, the method further includes turning off the fan in response to determining that the temperature is less than the temperature threshold.

Other aspects of the disclosure will become apparent by consideration of the detailed description and accompanying drawings.

### BRIEF DESCRIPTION OF THE DRAWINGS

FIG. 1 is a perspective view of a battery pack, in accordance with an embodiment of the disclosure.

FIG. 2 illustrates internal components of the battery pack of FIG. 1, in accordance with an embodiment of the disclosure.

FIG. 3A is a perspective rear view of the battery pack of FIG. 1, in accordance with an embodiment of the disclosure.

FIG. 3B is a perspective, semi-transparent view of the battery pack of FIG. 1 including a fan, in accordance with an embodiment of the disclosure.

FIG. 4A is a perspective view of a battery pack, in accordance with an embodiment of the disclosure.

FIG. 4B is a perspective rear view of the battery pack of FIG. 4A, in accordance with an embodiment of the disclosure.

FIG. 4C is a perspective, semi-transparent view of the battery pack of FIG. 4A including a fan, in accordance with an embodiment of the disclosure.

FIG. 5 is a flow chart of a method for controlling a temperature of a battery pack, in accordance with an embodiment of the disclosure.

FIG. 6 is a block diagram of a control system including a battery pack, in accordance with an embodiment of the disclosure.

Before any embodiments of the disclosure are explained in detail, it is to be understood that the present subject matter is not limited in its application to the details of construction and the arrangement of components set forth in the following description or illustrated in the following drawings. The present subject matter is capable of other embodiments and of being practiced or of being carried out in various ways.

### DETAILED DESCRIPTION

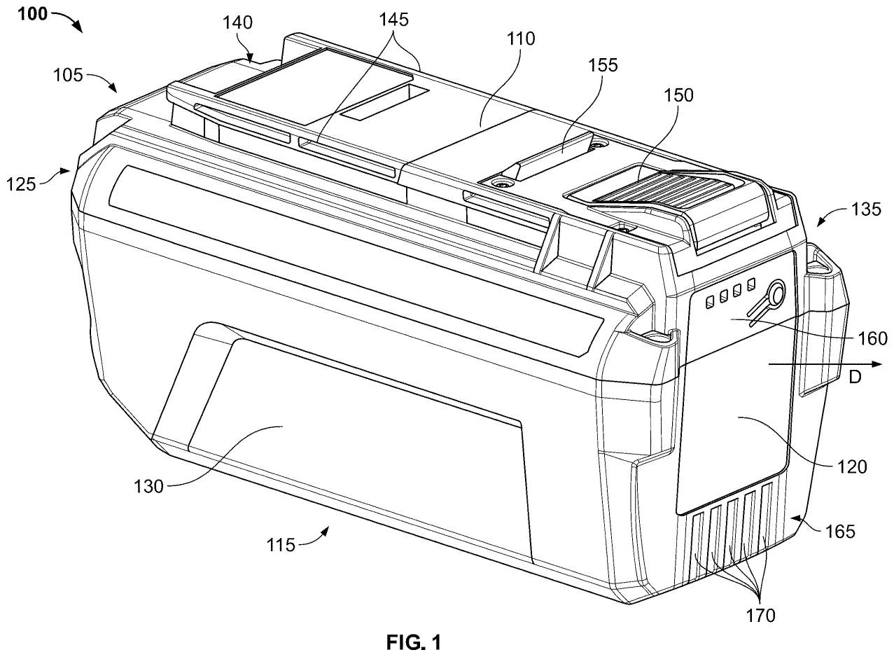

FIG. 1 illustrates a perspective view of a battery pack 100, according to some embodiments. In some examples, the battery pack 100 may be configured to be electrically and mechanically couple to a battery charger. The battery pack 100 may receive a charging current from the battery charger to charge the battery pack 100 according to a nominal charging voltage of the battery pack 100. In other examples, the battery pack 100 may be configured to electrically and mechanically couple to a power tool (or other electrical device). The power tool may be any power tool (e.g., a drill, a fastener driver, an impact driver, a reciprocating saw, etc.) able to receive power from the battery pack 100. The battery pack 100 may provide operational power to the power tool (or other electrical device). As illustrated, the battery pack 100 may include a housing 105. The housing 105 may include a top portion 110 and a bottom portion 115. The top portion 110 may be mechanically coupled to the bottom portion 115 to provide a first side 120, a second side 125, a third side 130, and a fourth side 135 of the battery pack 100. In some examples, the first side 120 (e.g., a front side) may be facing a front direction D of the battery pack 100. The second side 125 (e.g., a rear side) may be positioned opposite the first side 120. The third side 130 (e.g., a left side) may be positioned adjacent to both the first side 120 and the second side 125. The fourth side 135 (e.g., a right side) may be positioned opposite the third side 130.

In some examples, the top portion 110 may include a plurality of battery pack terminals 140 (e.g., an interface), one or more rails 145, a release mechanism 150, and a latch 155. The battery pack 100 may be electrically and mechanically coupled to a battery charger or a power tool (or another external device) via the plurality of battery pack terminals 140, one or more rails 145, and the latch 155. The latch 155 may engage a portion of a housing of a battery charger or a power tool when the battery pack 100 is mechanically coupled to the battery charger or the power tool. The release mechanism 150 is designed to be depressed to release the battery pack 100 from a battery charger or a power tool via the latch 155 when the battery pack 100 is coupled to the battery charger or the power tool. Although illustrated as rails 145, in other embodiments the battery pack 100 may include other forms to couple to a battery charger and/or device, for example but not limited to, a stem.

The first side 120 may further include a user interface 160 and an air inlet 165. In some examples, the user interface 160 is a LED gauge. The user interface 160 may receive user inputs and provide an indication of one or more characteristics of the battery pack 100 to a user. For example, the user interface 160 may include buttons, switches, dials, or the like to receive an input from a user. Additionally, the user interface 160 may include a plurality of indicators to provide an indication of the characteristic of the battery pack 100. In some examples, the plurality of indicators may be light-emitting diodes (“LEDs”), a display, and/or a touch-screen. In some examples, the characteristic of the battery pack 100 may be a state-of-charge (“SOC”), a state-of-health (“SOH”), a battery capacity, or the like. The air inlet 165 may be disposed on the first side 120 of the battery pack 100. The air inlet 165 may receive air from ambient surroundings of the battery pack 100. In some examples, the battery pack 100 may include additional air inlets. In some examples, the air inlet 165 may include a first plurality of openings 170 for air to pass through the air inlet 165. In some examples, the first plurality of openings 170 may be substantially rectangular slits. In other examples, the first plurality of openings 170 may be circular shaped, elliptical shaped, hexagonal shaped, a patterned surface, etc.

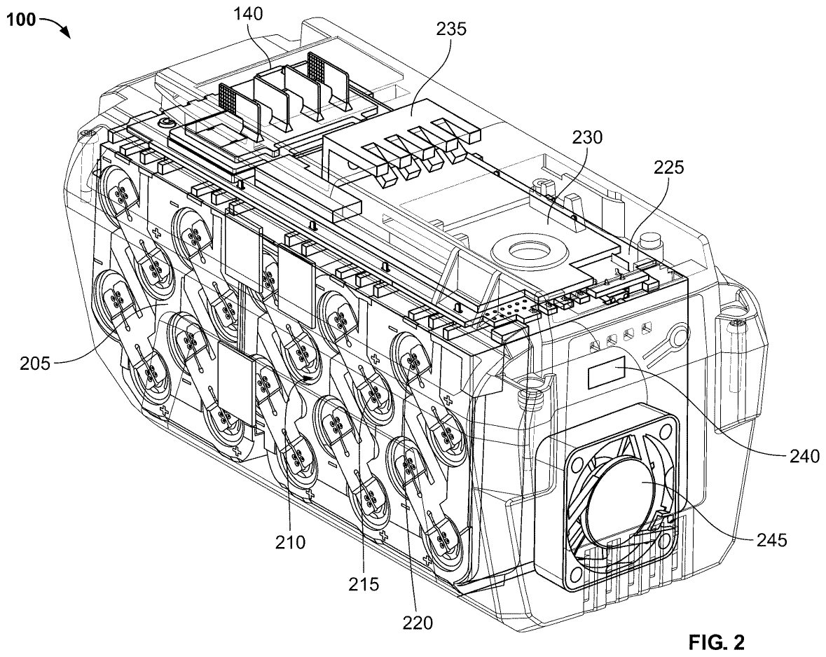

FIG. 2 illustrates internal components of the battery pack 100 of FIG. 1 according to some embodiments. A plurality of battery cells 210 may be disposed within the housing 105. The plurality of battery cells 210 may be, for example, lithium-ion battery cells or any other suitable battery cells. Each battery cell of the plurality of battery cells 210 may include a first battery terminal 215 (e.g., a positive battery terminal) and a second battery terminal 220 (e.g., a negative battery terminal). In some examples, each battery cell of the plurality of battery cells 210 may be positioned in an alternating sequence adjacent to each subsequent battery cell. In such examples, the first battery terminal 215 of one battery cell may be positioned proximate to the second battery terminal 220 of an adjacent battery cell of the plurality of battery cells 210. In other examples, each first battery terminal 215 is positioned proximate to the third side 130 and each second battery terminal 220 is positioned proximate to the fourth side 135. Although illustrated as cylindrical battery cells, in other embodiments the battery pack 100 may include one or more pouch cells, one or more prismatic cells, or other suitable battery cell.

The battery pack 100 may also include a circuit board 225. In some examples, the circuit board 225 may be a printed circuit board (“PCB”), a flexible PCB, or any other suitable electronic controller. In some examples, the circuit board 225 may be disposed proximate to the top portion 110. In other examples, the circuit board 225 may be disposed proximate to the first side 120, the second side 125, the third side 130, or the fourth side 135. In some examples, the circuit board 225 may control an operation of the battery pack 100. In some examples, the circuit board 225 may be mechanically coupled to a shell 230, a heat sink 235, and the plurality of battery pack terminals 140. In some examples, the shell 230 may cover a portion of the circuit board 225 and provide protection to the circuit board 225. In some examples, the heat sink 235 may dissipate heat generated by the circuit board 225 and/or the plurality of battery cells 210. In some examples, the heat sink 235 is attached to heat generating components of the circuit board 225

In some examples, the battery pack 100 further includes a temperature sensor 240 and a fan 245. The temperature sensor 240 may be a thermistor, a negative temperature coefficient (“NTC”) thermistor, a resistance temperature detector (“RTD”), a thermocouple, or the like. The temperature sensor 240 may be configured to sense a temperature of the plurality of battery cells 210. The temperature sensor 240 may be electrically coupled to the circuit board 225 and transmit one or more signals indicative of the temperature of the plurality of battery cells 210 to the circuit board 225. In other examples, the temperature sensor 240 may sense a temperature of another component of the battery pack 100 such as, for example, the circuit board 225, the heat sink 235, the plurality of battery pack terminals 140, etc. As illustrated in FIG. 2, the temperature sensor 240 is disposed within the housing 105 and proximate to the first side 120. In other examples, the temperature sensor 240 is disposed within the housing 105. In even further examples, the temperature sensor 240 may be disposed on the circuit board 225. The temperature sensor 240 may be disposed on, or proximate to, the second side 125, the third side 130, or the fourth side 135. Although illustrated as a single temperature sensor 240, in other embodiments, the battery pack 100 may include two or more temperature sensors. In such an embodiment, an average temperature may be extrapolated from the two or more temperatures sensors to determine an average temperature of the battery pack 100.

In some examples, the fan 245 is positioned within the housing 105. The fan 245 may be positioned proximate to the air inlet 165. In some examples, the fan 245 may cool the plurality of battery cells 210 and the circuit board 225 by providing cooling air received from the air inlet 165 in a direction of the plurality of battery cells 210. The fan 245 may be arranged in parallel with the plurality of battery cells 210. In some examples, the fan 245 may further include a fan motor and a plurality of fan blades. In some examples, the fan 245 is electrically coupled to the circuit board 225. The fan 245 may receive control signals from the circuit board 225. For example, the circuit board 225 may control operation of the fan 245 to induce air flow through the battery pack 100. In some examples, the fan 245 is located below the user interface 160. In some examples, the plurality of indicators provides an indication of the status of the fan 245

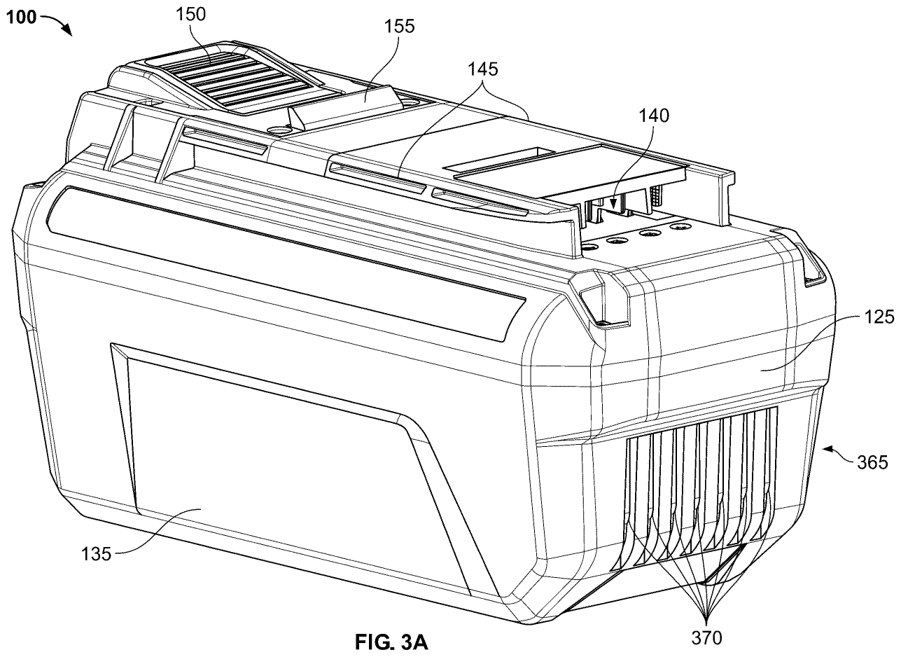

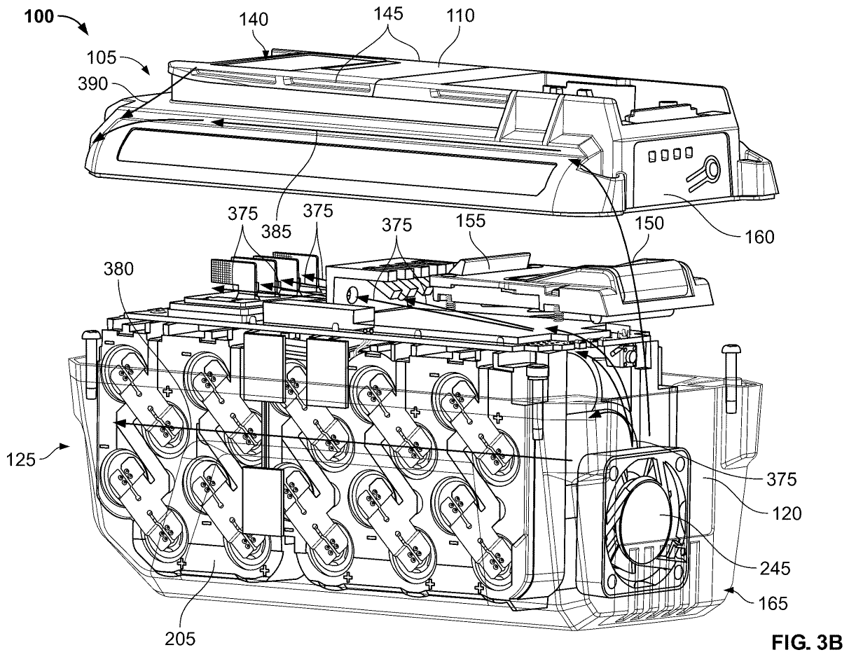

FIG. 3A illustrates a perspective rear view of the battery pack 100 of FIG. 1 showing the second side 125 and the fourth side 135, according to some embodiments. In some examples, the battery pack 100 may include an air outlet 365. The air outlet 365 may be disposed on the second side 125 of the battery pack 100. The air outlet 365 may exhaust air used to cool the plurality of battery cells 210 to the ambient surroundings of the battery pack 100. In some examples, the battery pack 100 may include additional air outlets (for example, located on other sides of battery pack 100). In some examples, the air outlet 365 may include a second plurality of openings 370 for air to pass through the air outlet 365. In some examples, the second plurality of openings 370 may be substantially rectangular slits. In other examples, the second plurality of openings 370 may be circular shaped, elliptical shaped, hexagonal shaped, a patterned surface, etc. The air outlet 365 may include the battery pack terminals 140 for mating with an external device.

FIG. 3B illustrates a perspective, semi-transparent view of the battery pack 100 of FIG. 1 including the fan 245, according to some embodiments. As illustrated in FIG. 3B, in some examples, the plurality of battery cells 210 may further include a plurality of channels 375. In some examples, each channel of the plurality of channels 375 extends from the third side 130 of the battery pack 100 to the fourth side 135 of the battery pack 100. In some examples, a channel of the plurality of channels 375 is formed between the circuit board 225 and the plurality of battery cells 210. In some examples, a channel of the plurality of channels 375 is formed between the circuit board 225 and the housing 105. The heat sink 235 may be positioned in a channel of the plurality of channels 375. Each channel of the plurality of channels 375 may be positioned between two adjacent battery cells of the plurality of battery cells 210 to allow air provided by the fan 245 to cool the plurality of battery cells 210. In some examples, there may be a greater or fewer number of channels of the plurality of channels 375 than illustrated in FIG. 3B. As stated above, the circuit board 225 may control operation of the fan 245 to induce air flow through the battery pack 100. For example, the circuit board 225 may control operation of the fan 245 to pull air from the surrounding environment of the battery pack 100 through the air inlet 165 along a first airflow path 380. The first airflow path 380 may traverse the entirety of the battery pack 100 from the first side 120 to the second side 125. Additionally, as the fan 245 pulls air along the first airflow path 380, air may pass through the plurality of channels 375.

Thus, the fan 245 may pull air along the first airflow path 380, and through the plurality of channels 375, to cool the plurality of battery cells 210 as air moves from the first side 120 to the second side 125. The fan 245 may pull air from the first airflow path 380 and exhaust the air through the air outlet 365. Alternatively, in some examples, the air inlet 165 may be disposed on the second side 125 of the battery pack 100 and the air outlet 365 may be disposed on the first side 120. In such examples, the fan 245 may be positioned proximate the air inlet 165 (or the air outlet 365) on the second side 125. Accordingly, the direction of the first airflow path 380 may be reversed and the fan 245 may pull air along the first airflow path 380 from the second side 125 to the first side 120.

Additionally, the circuit board 225 may control operation of the fan 245 to pull air from the surrounding environment of the battery pack 100 along a second airflow path 385. The second airflow path 385 may traverse the entirety of the battery pack 100 from the first side 120 to the second side 125. For example, the fan 245 pulls air through the air inlet 165 and along the second airflow path 385 to guide the air over specific electronic components (e.g., the plurality of battery pack terminals 140, the circuit board 225, the plurality of battery cells 210, MOSFETS, etc). Accordingly, the fan 245 may pull air from the second airflow path 385 and exhaust the air through the air outlet 365. In some examples, the circuit board 225 may control operation of the fan 245 to pull air from the surrounding environment of the battery pack 100 along a third airflow path 390. Thus, the fan 245 may pull air through an opening of the plurality of battery pack terminals 140 to cool the plurality of battery pack terminals 140. Accordingly, the fan 245 may pull air from the third airflow path 390 and exhaust the air through the air outlet 365. In some examples, the battery pack 100 includes a plurality of fans. For example, a first fan (e.g., the fan 245) may be used to pull air along the first airflow path 380 towards the air outlet 365 and a second fan may be used to pull air along the second airflow path 385 towards the air outlet 365. In some examples, the first fan pulls air along the second airflow path 385 towards the air outlet 365 and the second fan pulls air along the third airflow path 390 towards the air outlet 365.

In some examples, the fan 245 is oriented in an opposite direction (or a rotor of the fan operates in an opposite direction) than as described above with respect to FIG. 3B. For example, the fan 245 is positioned to induce airflow from the air outlet 365 and exhaust the air through the air inlet 165. Accordingly, the fan 245 may draw air through the air outlet 365 and/or the opening of the plurality of battery pack terminals 140. In such examples, the first airflow path 380, the second airflow path 385, and the third airflow path 390 may be reversed.

The fan 245 may draw air through the air outlet 365, along the first airflow path 380 in a reversed direction, and exhaust the air through the air inlet 165. The fan 245 may draw air through the air outlet 365, along the second airflow path 385 in a reversed direction, and exhaust the air through the air inlet 165. The fan 245 may draw air through the opening of the plurality of battery pack terminals 140, along the third airflow path 390 in a reversed direction, and exhaust the air through the air inlet 165.

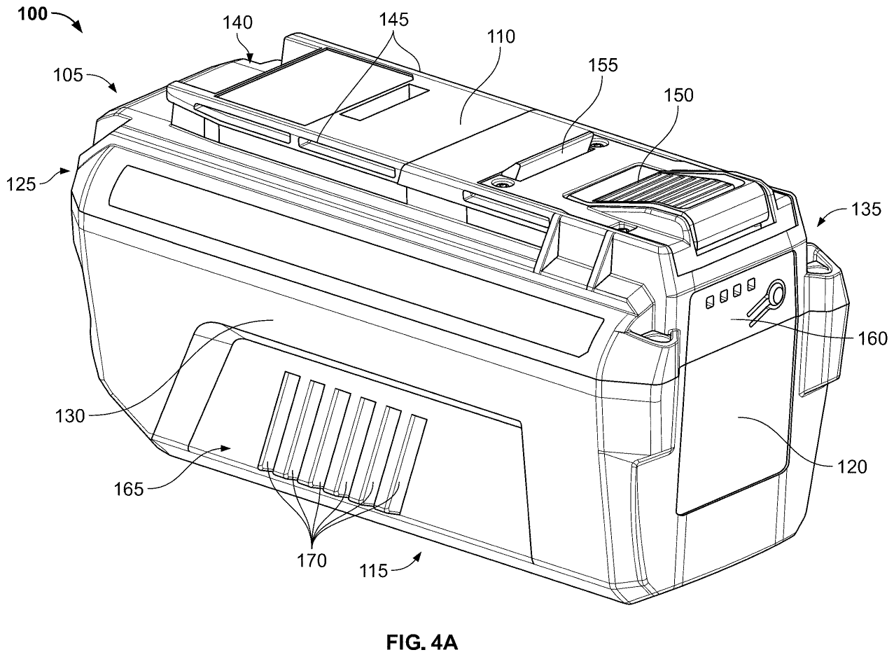

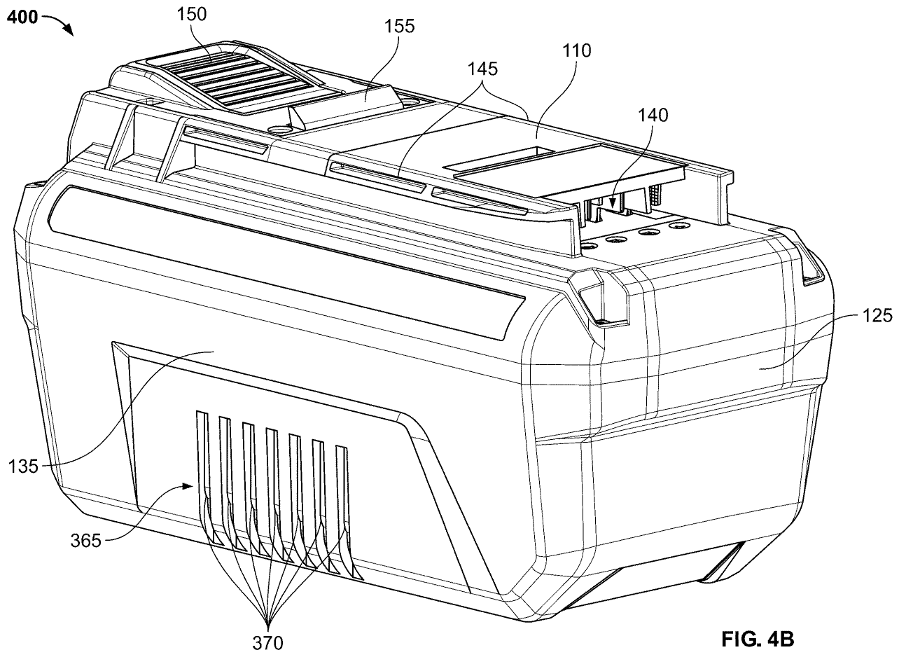

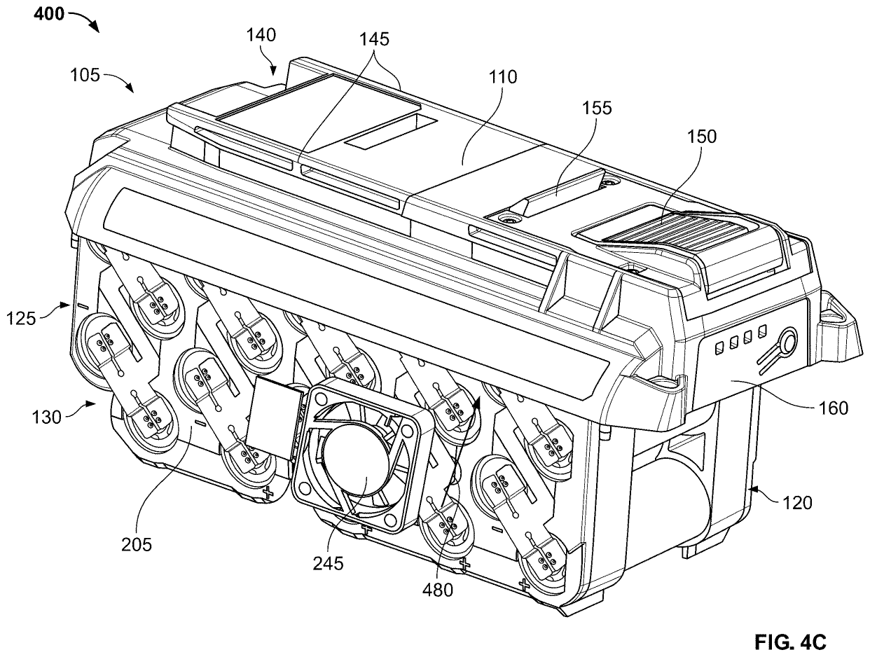

FIG. 4A illustrates a perspective view of a battery pack 400, according to some embodiments. The battery pack 400 may include similar components (e.g., mechanical and/or electrical components) to the battery pack 100, shown in FIG. 1. For example, the battery pack 400 may include the housing 105, the top portion 110, the bottom portion 115, the first side 120, the second side 125, the third side 130, the fourth side 135, the air inlet 165, the air outlet 365 (described in further detail below with respect to FIG. 4B), and the fan 245 (described in further detail below with respect to FIG. 4C). As illustrated in FIG. 4A, in some examples, the air inlet 165 may be disposed on the third side 130 of the battery pack 400. In some examples, the battery pack 400 may include additional air inlets. In some examples, the air inlet 165 may include the first plurality of openings 170 for air to pass through the air inlet 165. In some examples, the first plurality of openings 170 may be substantially rectangular slits. In other examples, the first plurality of openings 170 may be circular shaped, elliptical shaped, hexagonal shaped, a patterned surface, etc.

FIG. 4B illustrates a perspective rear view of the battery pack 400 of FIG. 4A showing the second side 125 and the fourth side 135, according to some embodiments. The battery pack 400 may include similar components (e.g., mechanical and/or electrical components) to the battery pack 100, shown in FIG. 3A. For example, the battery pack 400 may include the air outlet 365. As illustrated in FIG. 4B, in some examples, the air outlet 365 may be disposed on the fourth side 135 of the battery pack 400. The air outlet 365 may exhaust air used to cool the plurality of battery cells 210 to the ambient surroundings of the battery pack 400. In some examples, the battery pack 400 may include additional air outlets. In some examples, the air outlet 365 may include the second plurality of openings 370 for air to pass through the air outlet 365. In some examples, the second plurality of openings 370 may be substantially rectangular slits. In other examples, the second plurality of openings 370 may be circular shaped, elliptical shaped, hexagonal shaped, a patterned surface, etc.

FIG. 4C illustrates a perspective, semi-transparent view of the battery pack 400 of FIG. 4A including the fan 245, according to some embodiments. The battery pack 400 may include similar components (e.g., mechanical and/or electrical components) to the battery pack 100, shown in FIG. 3B. For example, the battery pack 400 may include the fan 245 and the plurality of channels 375. As illustrated in FIG. 4C, in some examples, the fan 245 may be positioned proximate the air inlet 165 relative to the third side 130. As stated above, each channel of the plurality of channels 375 extends from the third side 130 of the battery pack 100 to the fourth side 135 of the battery pack 100. Each channel of the plurality of channels 375 may be positioned between two adjacent battery cells of the plurality of battery cells 210 to allow air provided by the fan 245 to cool the plurality of battery cells 210. In some examples, the circuit board 225 may control operation of the fan 245 to pull air from the surrounding environment of the battery pack 400 through the air inlet 165 along a fourth airflow path 480. The fourth airflow path 480 may traverse the entirety of the battery pack 400 from the third side 130 to the fourth side 135. Additionally, as the fan 245 pulls air along the fourth airflow path 480, air may pass through the plurality of channels 375. Thus, the fan 245 may pull air along the fourth airflow path 480, and through the plurality of channels 375, to cool the plurality of battery cells 210 as air moves from the third side 130 to the fourth side 135. The fan 245 may pull air from the fourth airflow path 480 and exhaust the air through the air outlet 365. Alternatively, in some examples, the air inlet 165 may be disposed on the fourth side 135 of the battery pack 400 and the air outlet 365 may be disposed on the third side 130. In such examples, the fan 245 may be positioned proximate the air inlet 165 on the fourth side 135. Accordingly, the direction of the fourth airflow path 480 may be reversed and the fan 245 may pull air along the fourth airflow path 480 from the fourth side 135 to the third side 130.

Although described as being positioned on the sides of the battery pack 100 or the battery pack 400, in some examples, the air inlet 165 may be disposed on the bottom portion 115 and the air outlet 365 may be disposed on the top portion 110. In such examples, the fan 245 is positioned proximate to the air inlet 165 relative to the bottom portion 115. Accordingly, the fan 245 may pull air through the air inlet 165 from the bottom portion 115 to the top portion 110.

Alternatively, in some examples, the air outlet 365 may be disposed on the first side 120, the second side 125, the third side 130, or the fourth side 135 when the air inlet 165 is disposed on the bottom portion 115.

In some examples, the air inlet 165 may be disposed at a joint of two sides of the battery pack 100 or the battery pack 400. For example, the air inlet 165 may be disposed at a joint of the first side 120 and the third side 130. The air inlet 165 may be disposed at a joint of the first side 120 and the fourth side 135. The air outlet 365 may be disposed at a joint of the second side 125 and the third side 130. The air outlet 365 may be disposed at a joint of the second side 125 and the fourth side 135. Alternatively, the air inlet 165 may be disposed at the joint of the second side 125 and the third side 130. The air inlet 165 may be disposed at the joint of the second side 125 and the fourth side 135. The air outlet 365 may be disposed at the joint of the first side 120 and the third side 130. The air outlet 365 may be disposed at the joint of the first side 120 and the fourth side 135.

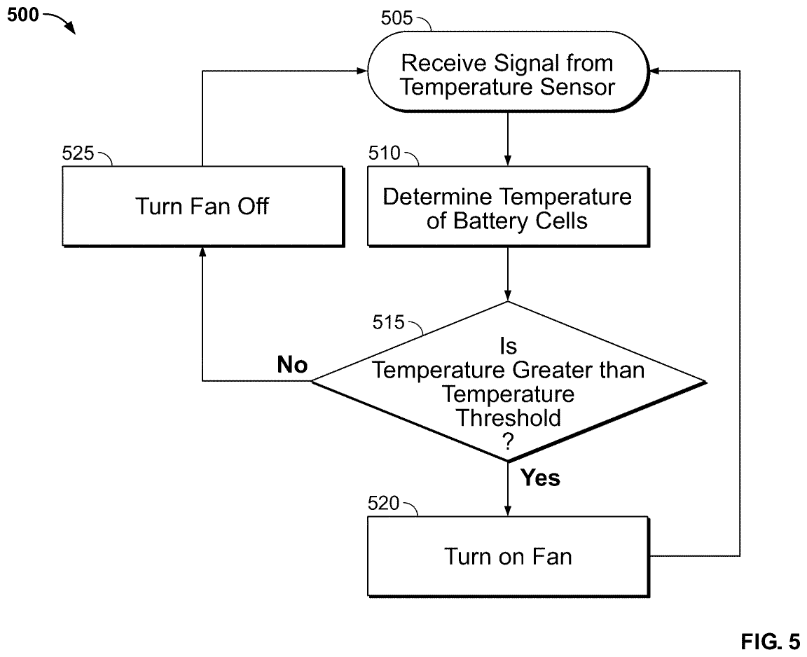

FIG. 5 is a flowchart illustrating a method 500 for controlling a temperature of a battery pack (e.g., the battery pack 100 or the battery pack 400), according to some embodiments. It should be understood that the order of the steps disclosed in the method 500 could vary. For example, additional steps may be added to the process and not all of the steps may be required, or steps shown in one order may occur in a second order. The method 500 begins at step 505 when the circuit board 225 (e.g., an electronic controller) receives a signal (e.g., a temperature signal) from the temperature sensor 240. For example, the temperature sensor 240 may sense a temperature of the plurality of battery cells 210, a temperature of the circuit board 225, a temperature indicative of inside the battery housing 105, and/or an average temperature of the battery pack 100 (or battery pack 400), and transmit a signal indicative of the temperature to the circuit board 225. The method 500 then proceeds to step 510.

At step 510, the circuit board 225 determines the temperature(s) based on the signal. The method 500 then proceeds to step 515. At step 515, the circuit board 225 determines whether the temperature(s) is greater than a first temperature threshold. For example, the circuit board 225 may compare the determined temperature(s) to a known temperature value stored in a memory of the circuit board 225. In some examples, the first temperature threshold may be 60 degrees Celsius. In other examples, the first temperature threshold may be greater than or less than 60 degrees Celsius. When the circuit board 225 determines that the temperature(s) is less than the first temperature threshold, the method 500 returns to step 505 and the circuit board 225 continues to receive the signal from the temperature sensor 240. When the circuit board 225 determines that the temperature of the plurality of battery cells 210 is greater than the first temperature threshold, the method 500 then proceeds to step 520.

At step 520, the circuit board 225 transmits one or more control commands to the fan 245 to turn on the fan 245 for a first speed. For example, in response to the circuit board 225 determining that the temperature of the plurality of battery cells 210 is greater than the first temperature threshold, the fan 245 moves air from the air inlet 165 to the air outlet 365. In some examples, when the fan 245 is turned on, the fan 245 moves air through the plurality of channels 375. Once the fan 245 is turned on at step 520, the method 500 may return to step 505 to continue receiving the signal from the temperature sensor 240. In such examples, the circuit board 225 repeats step 505 and receives the signal indicative of the temperature of the plurality of battery cells 210 from the temperature sensor 240 and may perform steps 510-515 as described above. When the fan 245 is turned on and the circuit board 225 determines that the temperature of the plurality of battery cells 210 is less than the first temperature threshold at step 515, the circuit board 225 transmits one or more control commands to the fan 245 to turn off the fan 245. For example, when the circuit board 225 determines that the temperature(s) is less than the first temperature threshold, the method 500 proceeds to step 525. At step 525, the circuit board 225 transmits the one or more control commands to the fan 245 to turn off the fan 245 before returning to step 505 to continue receiving the signal from the temperature sensor 240.

In some examples, the circuit board 225 determines whether the temperature(s) is greater than a second temperature threshold. For example, the circuit board 225 may compare the determined temperature(s) to a known temperature value stored in a memory of the circuit board 225. When the circuit board 225 determines that the temperature(s) is greater than the second temperature threshold, the circuit board 225 transmits one or more control commands to the fan 245 to turn on the fan 245 for a second speed. In some examples, the second temperature threshold is greater than the first temperature threshold. In some examples, the second speed is greater than the first speed.

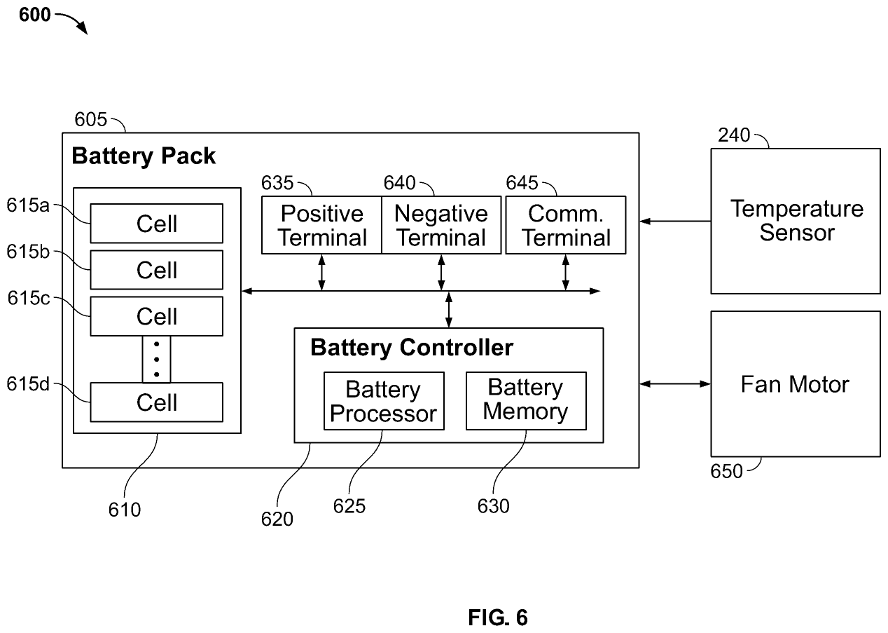

FIG. 6 is a block diagram of a control system 600 of a battery pack 605, according to some examples. In some examples, the battery pack 605 may include similar components (e.g., mechanical and/or electrical components) to the battery pack 100, shown in FIG. 1, and/or the battery pack 400, shown in FIG. 4A. The control system 600 may include other components not pictured in FIG. 6, for example a battery charger, a power tool, a motor, a solenoid, and/or other mechanical and/or electrical components described above. The battery pack 605 may include a stack 610 consisting of one or more battery cells 615. In some examples, the one or more battery cells 615 may be the same as the plurality of battery cells 210. In some examples, the one or more battery cells 615 are electrically connected to each other in a series-type manner. In other examples, the one or more battery cells 615 are electrically connected to each other in a parallel-type manner. In still other examples, the one or more battery cells 615 are electrically connected to each other in a combination of a series-type and a parallel-type manner.

The battery pack 605 may further include a battery pack controller 620 consisting of a battery processor 625 and a battery memory 630. In some examples, the battery pack controller 620 may be included as a part of the circuit board 225. The battery pack 605 may further include a positive battery terminal 635 and a negative battery terminal 640. The positive battery terminal 635 and the negative battery terminal 640 may be configured to electrically and/or mechanically couple to corresponding terminals of a battery charger or a power tool. In some examples, the battery pack 605 includes a communication terminal 645, which may be configured to electrically, mechanically, and/or communicatively couple to one or more communication terminals of a battery charger or a power tool.

In some examples, such as the block diagram of FIG. 6, the one or more battery cells 615 are connected to the battery pack controller 620. The battery pack controller 620 controls the power delivered to the positive battery terminal 635 and the negative battery terminal 640 (for example, via control of a discharge field-effect transistor (FET), a charge FET, and/or other FETs located within the battery pack 605). In some examples, the battery pack controller 620 controls the power by allowing or prohibiting power. Additionally, in some examples, the battery pack controller 620 controls the power by allowing a percentage of power generated by the one or more battery cells 615 to be output. In some embodiments, the amount of power delivered between the battery terminals 635, 640 is approximately 100% of power possibly generated by the one or more battery cells 615.

In some examples, the battery processor 625 may include a control unit, an arithmetic logic unit, and one or more registers. Additionally, the battery memory 630 may include program storage and/or data storage. The battery memory 630 may be flash memory, random access memory, solid state memory, another type of memory, or a combination of these types.

The battery pack controller 620 may further include one or more input units and/or output units. In some examples, the one or more input units may be configured to receive a plurality of inputs such as a mode switch signal, signals from one or more sensors (e.g., the temperature signal), a battery current signal, a battery temperature signal, or a battery voltage signal. In some examples, the one or more output units may be configured to transmit a plurality of outputs such as a signal to control an operation of the fan 245, a signal to control a plurality of light-emitting diodes (LEDs), or a signal to control a plurality of FETs connected to the motor. For example, the battery pack controller 620 may include an IC chip, PID controller, programmable logic controllers, and/or the like. The battery processor 625 may include a microprocessor, a microcontroller, or another suitable programmable device.

The battery memory 630 is a non-transitory computer readable medium that includes, for example, a program storage area and a data storage area. The program storage area and the data storage area can include combinations of different types of memory, such as read-only memory (“ROM”), random access memory (“RAM”) (e.g., dynamic RAM [“DRAM”], synchronous DRAM [“SDRAM”], etc.), electrically erasable programmable read-only memory (“EEPROM”), flash memory, a hard disk, an SD card, or other suitable magnetic, optical, physical, or electronic memory devices. The battery processor 625 may be connected to the battery memory 630 and executes software instructions that are capable of being stored in a RAM of the battery memory 630 (e.g., during execution), a ROM of the battery memory 630 (e.g., on a generally permanent basis), or another non-transitory computer readable medium such as another memory or a disc. Software included in the implementation of the battery pack 605 or the fan 245 can be stored in the battery memory 630 of the battery pack controller 620. The software includes, for example, firmware, one or more applications, program data, filters, rules, one or more program modules, and other executable instructions. The battery pack controller 620 may retrieve from memory and execute, among other things, instructions related to the control of the charging and/or discharging of the battery pack 605. In other examples, the battery pack controller 620 may retrieve from memory and execute, among other things, instructions related to the control of the fan 245 described herein. In other constructions, the battery pack controller 620 includes additional, fewer, or different components. As illustrated, the battery pack controller 620 may be electronically and/or communicatively coupled to a fan motor 650 and the temperature sensor 240. The temperature sensor 240 may transmit one or more signals indicative of a temperature of the one or more battery cells 615 to the battery pack controller 620. The fan motor 650 may receive control signals from the battery pack controller 620 and operate the fan 245 based on the control signals.

Although the present subject matter has been described in detail with reference to certain preferred embodiments, variations and modifications exist within the scope of one or more independent aspects of the present subject matter as described.

What is claimed is:

1. A battery pack comprising:
a housing having
a first side facing a front direction,
a second side positioned opposite the first side,
a third side positioned adjacent to both the first side and the second side,
a fourth side positioned opposite the third side,
an air inlet disposed on the first side, and
an air outlet disposed on the second side;
a plurality of battery cells;
a fan positioned within the housing;
a temperature sensor configured to sense a temperature; and
an electronic controller configured to:
receive a signal from the temperature sensor,
determine, based on the signal, the temperature,
determine whether the temperature is greater than a first temperature threshold, and
turn on the fan for a first speed to move air from the air inlet to the air outlet in response to determining that the temperature is greater than the first temperature threshold.

2. The battery pack of claim 1, wherein the battery pack includes an interface for mating with an external device, the air outlet comprises the interface.

3. The battery pack of claim 2, wherein the electronic controller is provided on a PCB, a channel is formed between the PCB and the battery cells and/or between the PCB and the housing, the fan moves air through the channel.

4. The battery pack of claim 1, further comprising a plurality of channels, each channel of the plurality of channels is positioned between two adjacent battery cells of the plurality of battery cells, the fan moves air through the plurality of channels.

5. The battery pack of claim 1, wherein the fan is positioned proximate to the air inlet or the air outlet.

6. The battery pack of claim 1, wherein the fan is located below a LED gauge.

7. The battery pack of claim 1, wherein the fan is further configured to:
pull air through the air inlet;
cool the plurality of battery cells and/or the electronic controller using the air pulled from the air inlet; and
exhaust the air from the air outlet.

8. The battery pack of claim 3, wherein the PCB includes a heatsink attached to heat generating components, the heatsink is positioned in the channel.

9. The battery pack of claim 1, wherein if the temperature is higher than a second temperature threshold, the electronic controller controls the fan to run in a second speed, wherein the second temperature threshold is higher than the first temperature threshold, the second speed is higher than the first speed.

10. The battery pack of claim 1, further comprising a LED gauge which is able to show the status of the fan.

11. The battery pack of claim 1, wherein the fan is arranged in parallel with the battery cells.

12. The battery pack of claim 1, wherein each battery cell of the plurality of battery cells includes a first battery terminal and a second battery terminal, each first battery terminal is positioned proximate to the third side, each second battery terminal is positioned proximate to the fourth side.

13. The battery pack of claim 1, wherein the air inlet includes a first plurality of openings for air to pass through, and
wherein the air outlet includes a second plurality of openings for air to pass through.

14. The battery pack of claim 1, wherein the fan is further configured to:
pull air through the air inlet;
cool the plurality of battery cells using the air pulled from the air inlet; and
exhaust the air from the air outlet.

15. A method for controlling a temperature of a battery pack including an electronic controller, the method comprising:
receiving, via the electronic controller, a signal from a temperature sensor;
determining, via the electronic controller and based on the signal, a temperature;
determining, via the electronic controller, whether the temperature is greater than a temperature threshold; and
turning on a fan to move air from an air inlet to an air outlet in response to determining that the temperature is greater than the temperature threshold.

16. The method of claim 15, further comprising a plurality of channels, each channel of the plurality of channels is positioned between two adjacent battery cells of the plurality of battery cells.

17. The method of claim 16, wherein turning on the fan moves air through the plurality of channels.

18. The method of claim 15, wherein the air inlet includes a first plurality of openings for air to pass through, and
wherein the air outlet includes a second plurality of openings for air to pass through.

19. The method of claim 15, wherein the method further comprises:
pulling air, via the fan, through the air inlet;
cooling the plurality of battery cells using the air pulled from the air inlet; and
exhausting the air from the air outlet.

20. The method of claim 15, wherein the method further comprises:
turning off the fan in response to determining that the temperature is less than the temperature threshold.
